(19) United States
(12) Patent Application Publication
(10) Pub. No.: US 2006/0242424 A1
(43) Pub. Date: Oct. 26, 2006

(54) Identity authentication based on keystroke latencies using a genetic adaptive neural network

(76) Inventors: Fred L. Kitchens, Muncie, IN (US); Sushil Sharma, Muncie, IN (US); Queen Esther Booker, Mankato, MN (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/112,337

(22) Filed: Apr. 22, 2005

(51) Int. Cl. H04L 9/00; H04K 1/00

(52) U.S. Cl. 713/183

(57) ABSTRACT

A system and method identify the person who is using a keyboard based on keystroke latencies as the person types certain key combinations. In some embodiments the latencies are monitored as the person types a password, while in others they are monitored as the person types other information and continues to use the computer. In some embodiments the identification yields a binary result (whether the latency profile matches the profile stored for a particular user), while in others a confidence level is given. A mismatch, or a confidence level below a particular threshold, results in a request for further identity verification, creation of a log entry, immediate notification of responsible personnel, or denial of access (or continued access).

### TECHNICAL FIELD

The present invention relates generally to a user authentication system or method, and more particularly relates to a user authentication method based on a password and keystroke latencies using a neural network.

### BACKGROUND

Computers and computer networks have become a standard part of business operations. The dependency on computers to store and process information makes the task of securing access one of great importance. While there are software applications to detect attempted virus intrusions via downloads or emails, and firewalls to protect unauthorized entry from electronic connectivity, few advancements have been made in protecting the physical systems that are accessed via passwords typed on the keyboard.

In the 1990s, security was based on the accurate identification of the computer user by asking the user to enter his or her name and password. Today, network access software such as Windows NT, Windows 2000, and Secure Shell (ssh) “remembers” the user name so a potential intruder only has to guess or enter the user's password. While this type of software is easier for the user, it also reduces the levels of information that has to be ascertained to obtain access to a business's system. Once a person has gained access to a computer system, she has the ability to modify data that is authorized for the user whose system has been compromised. Therefore, reliable software is needed to further secure physical access.

Keystroke authentication adds an additional measure of security. Keystroke authentication is a process by which an individual is identified by a person's keyboard typing rhythm of a familiar set of characters. However, previous attempts at creating a user authentication system employing keystroke authentication have met with only limited success. Early research suggested to some that names or passwords alone could not provide enough typing information to make a good identification. However, it has since been proven possible to authenticate the identity of a user based on information related to latency periods between keystrokes. Some of the same variables that make a handwritten signature a unique human identifier also provide a unique digital “signature” in the form of a stream of latency periods between keystrokes.

The keystrokes authentication approach has two main types of errors. The first is the false accept rate (FAR), denoting the ratio that an imposter gains access. The second is the false reject rate (FRR), denoting the ratio that the owner fails. No keystroke timing-based authentication system has yet been able to adequately differentiate between imposter data and user data, although many methods have been employed. One such method was a signature-curve map, visualized by plotting the latency period for each keystroke in succession. This process involved visualizing the signature by plotting characters typed versus latency times between successive keystrokes. The points obtained were joined to obtain a “signature-curve.”

A second method compared the mean latency period of two signatures, summarizing the data as sets of vectors, each consisting of the four vectors of latency values. The mean reference signature, M, is then given by:
M={Mᵤₛₑᵣₙₐₘₑ+M_{password}+M_{firstname}+Mₗₐₛₜₙₐₘₑ}
The signature being tested may then be called T, the corresponding set of vectors for the test signatures using the same model. M was compared to T by determining the magnitude of the difference between the two vectors. A suitable threshold for an acceptable size of the magnitude is then applied. A threshold was set for each individual user based on a measure of the variability of his/her signatures. A user who has little variability in his/her signatures is given a low threshold while another user with greater variability is assigned a greater threshold for accepting his/her test signatures.

The first model was rejected as too variant. The second model resulted in an FAR of 0.25 percent (2 out of 810) and an FRR of 16.36 percent (27 out of 165) over all the trials. However, the study involved user name, first name, last name and password, which is far more information than is currently required when accessing a computer system.

In U.S. Pat. No. 5,557,686 by Brown, et al., incorporated in its entirety by reference herein, an apparatus was disclosed for identifying users on name alone with complete exclusion of imposters and minimal false alarm rates. The apparatus used a back propagation neural network to develop the model but the disclosure did not include passwords nor did it describe the length of the user names involved.

In U.S. Pat. No. 6,151,593 by Cho, et al., incorporated in its entirety by reference herein, a user authentication apparatus was disclosed based on a password and a typing pattern to type the password by using a neural network. The Cho patent discloses the use of short-length phrases and claims a neural network that is an autoassociative multilayer perceptron trained by an error back propagation algorithm.

In U.S. Patent Publication No. 2004/0059950 by Bender, et al., incorporated in its entirety by reference herein, a user recognition and identification system was disclosed based on text entered by a user at a keyboard and evaluated against previously recorded keystrokes by the user for the presence of repeatable patterns that are unique to the individual. Bender, et al., record both dwell-time (how long the key is depressed) and flight-time (time from release of one key to depression of the next) for each keystroke. Bender, et al., also consider each user's keystroke patterns for different key-combinations (mini-rhythms). Third, Bender, et al., state, “in the present invention it is the subject who learns, not the system,” requiring the subject to “learn” a key phrase so well that it can be typed without thinking (possibly invoking muscular memory among other things), thereby expecting the user to develop a pattern of typing for a given phrase. Finally, Bender, et al., require the same key words or phrase to be typed for authentication purposes as was used for training.

There still exists a need to develop a user authentication apparatus and method that have a low error rate and are trained using only a particular user's typing patterns. Some systems and methods that embody the present invention address this need.

### SUMMARY

The present disclosure relates to a user authentication apparatus using a neural network trained with a genetic algorithm. It is an object of many embodiments of the present invention to provide a cost-effective, unobtrusive security addition to existing authentication processes.

The disclosure also discusses a neural network model for all users of a system. With a universal model, the system could be able to not only catch an imposter, but also identify the imposter if he is “known” to the system.

Further objects, features, and advantages will become apparent from a consideration of the following description and accompanying drawings. Related objects and advantages of the present invention will be apparent from the following description.

### BRIEF DESCRIPTION OF THE DRAWINGS

FIG. 1 is a block diagram of a system that implements one embodiment of the present invention.

FIG. 2 is a data flow diagram of development and use of a user keystroke latency profile according to the embodiment illustrated in FIG. 1.

FIG. 3 is a flowchart of a process according to the embodiment illustrated in FIG. 1.

FIG. 4 is a chart showing Average Latency Patterns for keystrokes by the Subjects.

### DESCRIPTION

For the purpose of promoting an understanding of the principles of the invention, reference will now be made to certain embodiments, including those illustrated in the drawings, and specific language will be used to describe them. It will nevertheless be understood that no limitation of the scope of the invention is thereby intended, such alterations and further modifications in the illustrated device, and such further applications of the principles discussed herein being contemplated as would normally occur to one skilled in the art to which the invention relates.

A properly designed neural network can approximate an unknown finction to any desired degree of accuracy. For example, some applications of neural network computing can identify patterns in non-linear or noisy data. This computing method combines hidden variables (nodes) between the dependent and independent data during the processing of data, developing a number of coefficients (weights) based on the total number of variables. Each hidden variable has a relationship with each dependent and independent variable, creating many different patterns and paths that a set of inputs can take to reach the output. Since input variables can have different paths, a well-trained neural network will at least match solutions found by other non-linear or linear models when dealing with non-linear or noisy data.

The use of neural networks for pattern matching is well-established. Finding the right neural network model is difficult, being complicated by the fact that the solution space may contain several locally optimal solutions. Currently, there are no generally accepted, established rules for setting the number of hidden variables (nodes) or the number of hidden levels (parameters). Since the functions to be estimated are generally unknown, it is difficult to set these parameters to avoid convergence to a local optimum.

An important consideration in artificial neural networks (ANNs) is the training algorithm. These include, but are not limited to, back propagation, simulated annealing, tabu search, gradient descent techniques, ordinary least squares and genetic algorithms. Each of the training algorithms has its advantages and disadvantages. For example, back propagation has a tendency to locate and return a local optimum. This tendency does not provide the best solution, but converges fairly quickly, and the number of times it finds a local optimum is often not significant. The genetic adaptive method, however, rarely settles on a local optimum, but its convergence time is significantly higher.

The genetic algorithm training method was introduced in 1975 by John Holland. Inspired by Darwin's theory about evolution, this training algorithm uses methods such as reproduction, crossover and mutation to solve problems. The algorithm starts with a set of solutions called the population. Solutions from one population are used to form a new population, which may be better (under a given fitness metric) than the original population.

The solutions selected to form new solutions are selected according to their fitness: the more suitable they are the more chances they have to reproduce. These new solutions are referred to as “offsprings.” This process is repeated until some condition (for example, generating a predetermined number of candidates in a population or achieving a predetermined improvement of the best solution) is satisfied. There are three basic parameters of a genetic algorithm: crossover probability, mutation probability and population size. Crossover probability characterizes how often a crossover will be performed. If there is no crossover, the set of offspring is an exact copy of the parents. If there is crossover, the set of offspring is made from parts of parents' chromosomes. If crossover probability is 100%, then all offsprings are created by crossover. If it is 0%, a whole new generation is made from exact copies of chromosomes from the old population, but this does not mean that the new generation is the same. Crossover is preferably performed so that the new solutions will have good parts of old chromosomes and the new chromosomes will be better.

Mutation probability indicates how often parts of chromosomes will mutate. If there is no mutation, offsprings are taken after crossover (or copy) without any change. If mutation is performed, part of the chromosome is changed. If mutation probability is 100%, the entire chromosome is changed, if it is 0%, nothing is changed. Mutation is made to prevent the algorithm from falling into local extrema.

Population size indicates how many chromosomes are in the population (in one generation). If there are too few chromosomes, the algorithm only has a few possibilities to perform crossover and only a small part of the search space is explored. If there are too many chromosomes, the algorithm significantly slows. After some limit (which depends mainly on encoding and the problem), it is not useful to increase population size, because it slows the algorithm for very little marginal improvement in quality.

In addition to these parameters, the algorithm also requires a selection process. Chromosomes are selected from the population to be parents to crossover. The problem is how to select these chromosomes. According to Darwin's evolution theory, the best chromosome should survive and create new offspring. There are many methods for selecting the best set of chromosomes; however, a preferred embodiment uses an “elitism” process. Elitism first copies the best chromosomes (or a few best chromosomes) of the old population to the new population, then continues with the crossover and mutation processes. Elitism can rapidly increase the performance of the genetic algorithm, because it prevents losing the best solution. This process has been shown to identify patterns in noisy, longitudinal data such as that from financial markets.

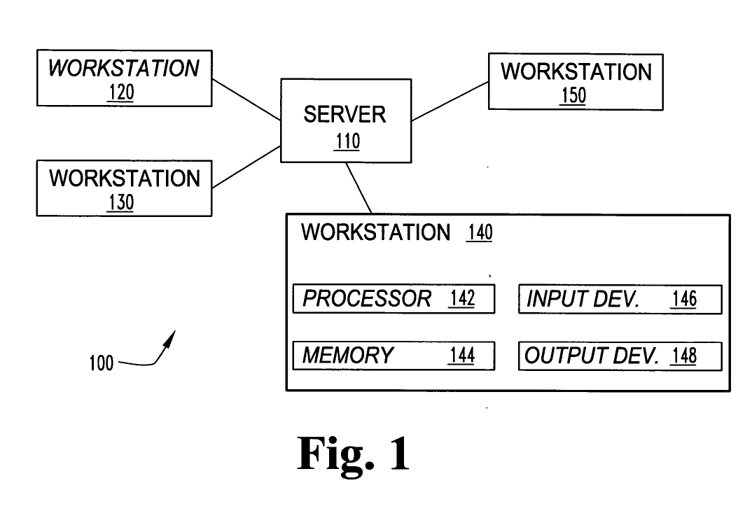

A first embodiment presents a system for user authentication based on a password and keystroke latencies using a genetic adaptive neural network, as is shown generally in FIG. 1 and discussed below. The system 100 shown in FIG. 1 includes a server 110 and workstations 120, 130, 140, and 150, though more, fewer, and/or different devices are included in typical implementations. Workstation 140 includes processor 142, memory 144, one or more input devices 146, and one or more output devices 148. In various embodiments, processor 142 is of a programmable type; a dedicated, hardwired state machine; or a combination of these. Processor 142 performs in accordance with operating logic that can be defined by software programming instructions, firmware, dedicated hardware, a combination of these, or in a different manner as would occur to those skilled in the art. For a programmable form of processor 142, at least a portion of this operating logic can be defined by instructions stored in memory 144. Programming of processor 142 can be of a standard, static type; an adaptive type provided by neural networking, expert-assisted learning, fuzzy logic, or the like; or a combination of these.

As illustrated, memory 144 is a computer-readable electronic medium integrated with processor 142. Alternatively, memory 144 can be separate from or at least partially included in one or more of processor 142. Memory 144 can be of a solid-state variety, electromagnetic variety, optical variety, or a combination of these forms. Furthermore, memory 144 can be volatile, nonvolatile, or a mixture of these types. Memory 144 can include a floppy disc, cartridge, or tape form of removable electromagnetic recording media; an optical disc, such as a CD or DVD type; an electrically reprogrammable solid-state type of nonvolatile memory, and/or such different variety as would occur to those skilled in the art. In still other embodiments, such devices are absent.

Processor 142 can be comprised of one or more components of any type suitable to operate as described herein. For a multiple processing unit form of processor 142, distributed, pipelined, and/or parallel processing can be utilized as appropriate. In one embodiment, processor 142 are provided in the form of one or more general purpose central processing units that interface with other components over a standard bus connection; and memory 144 includes dedicated memory circuitry integrated within processor 142, and one or more external memory components including a removable disk. Processor 142 can include one or more signal filters, limiters, oscillators, format converters (such as DACs or ADCs), power supplies, or other signal operators or conditioners as appropriate to operate workstation 140 in the manner described in greater detail herein.

Input devices 146 include a keyboard for entry of information, as is understood in the art, though additional devices are included in various alternative embodiments. Such additional devices include, but are not limited to, scanners, bio-identification devices, smart card readers, sensors, and the like. Output devices 148 include, but are not limited to, monitors, printers, audio speakers, headphones, and recorders adapted to store information on a variety of media.

While the illustrated embodiment of system 100 includes a networked system, other embodiments are stand-alone computer systems. Authentication systems may be local and/or distributed, as will be understood by those skilled in the art. Further, storage of software and profiles as discussed herein may be local, server-based, distributed, or a combination thereof as would occur to one skilled in the art.

The system according to this embodiment improves on certain existing systems in various ways. First, this embodiment is useful with current network systems that maintain the login name but require a user to enter a password to authenticate entry. This system is less cumbersome for practical application. Some existing systems have required subjects to type far more data than today's users are accustomed to typing for security clearance into a system (first name, last name, user name, and password). Other models have been inconsistent with the majority of computer access (user names only, passwords for long-term security keys, etc.). This present system focuses on only a few sets of keystrokes that the typical user would encounter in a day-to-day operation. The genetic neural network model with fewer independent variables produces better imposter pass rates and false alarm rates than much existing art. The system selects the best data for a genetic adaptive neural network based on the sigmoid function:
Sigmoid(x)=1/(1+e^{-x})

This model was chosen because of the flexible, non-linear nature of the genetic adaptive neural network. The sigmoid function is one preferable fitness function used in the neural network model that can be used to improve the mean-latency analysis; however, there are numerous other neural network models that are suitable and contemplated by the invention, such as (but not limited to) other genetic algorithms, back propagation, simulated annealing, tabu search, gradient descent and ordinary least squares.

A second way in which in the preferred embodiment system improves on certain existing art is that the present neural network can be implemented as a part of an existing authentication algorithm undetectable to the user, thereby avoiding a perceptible change to the login process. A third way in which the preferred embodiment improves on the some existing art is that once a proper login is confirmed, the system continuously monitors the user's keystroke latencies to continuously confirm that the typist continues to be the same user as was originally authenticated. Such an advantage can be critically important in that far and away the primary means by which a computer system's security is breached is simply the misappropriation of an authorized user's password. In accordance with the present invention, even if an unauthorized person did in fact use an authorized user's password, the system would not recognize the imposter's keystroke signature as that of the authorized user's and would deny or terminate access to the system.

Once the system suspects an unauthorized user or operator, it can do many things, such as but not limited to auto-sending a message to IT or security personnel to inform them that an unauthorized user is typing on a particular keyboard at a specific location, instantly terminate access to the system, request additional verification by the user, and the like.

Moreover, the system can be adapted to detect when the typist is stressed, under undue duress, excited, angry, or experiencing other extreme circumstances. Some such further applications include the system detecting the mood or attitude of the typist and, when in an instant messaging mode (for example, when the interface focus receiving the keystrokes is an instant messaging program), generating a message to the receiver that, for example, the typist or message sender is angry, excited, under duress, etc. Such an application is particularly beneficial in detecting when a user may be under extreme duress. Such a case may be when a user is being held hostage or being forced to type against his or her will while possibly at gunpoint or knifepoint.

This embodiment also includes applying a neural network model to latency data for all users of a system (e.g., all employees with access to a computer system). With a universal model, the system may be able not only to catch an imposter, but also to identify the imposter if he is “known” to the system (e.g., a fellow employee).

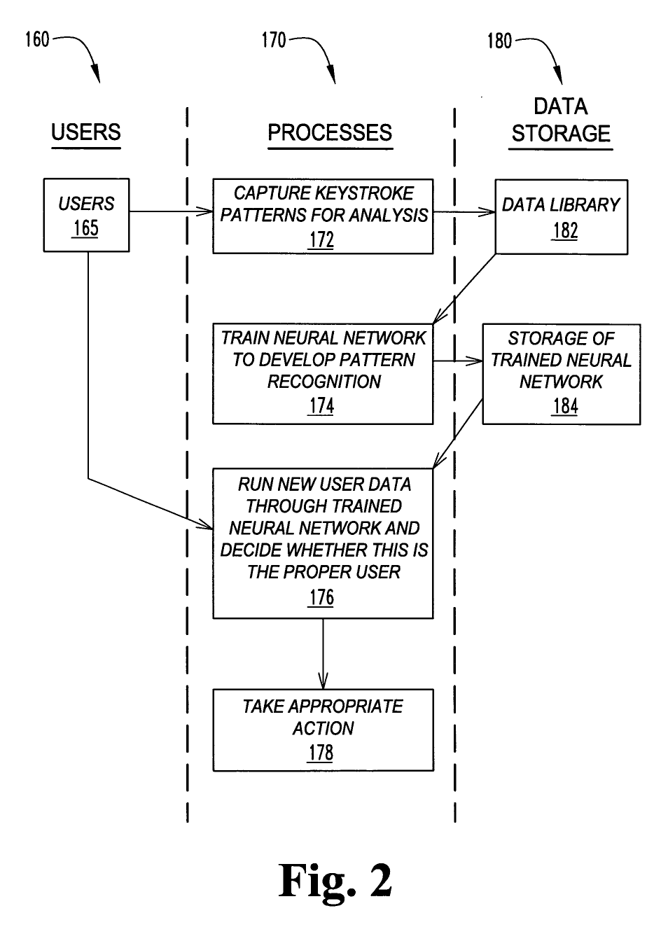

A data flow diagram describing the development and use of a user profile by this embodiment is shown in FIG. 2, including “users” section 160, “processes” section 170, and “data storage” section 180. Users block 165 reflects the users' keystroke input into the system, which feeds both blocks 172 and 176. Block 172 reflects the capture of keystroke patterns for analysis, which provides data to be stored in data library 182. Information from data library 182 is used to train a neural network (using techniques that would occur to those skilled in the art) to recognize the particular user's keystroke pattern. The trained neural network is stored as a profile at block 184.

This trained neural network (profile) from block 184 is combined at block 176 with new keystroke latency data from user block 165 to decide whether the current user is the same person as that for whom the profile was developed. Appropriate action is taken at block 178 based on that decision.

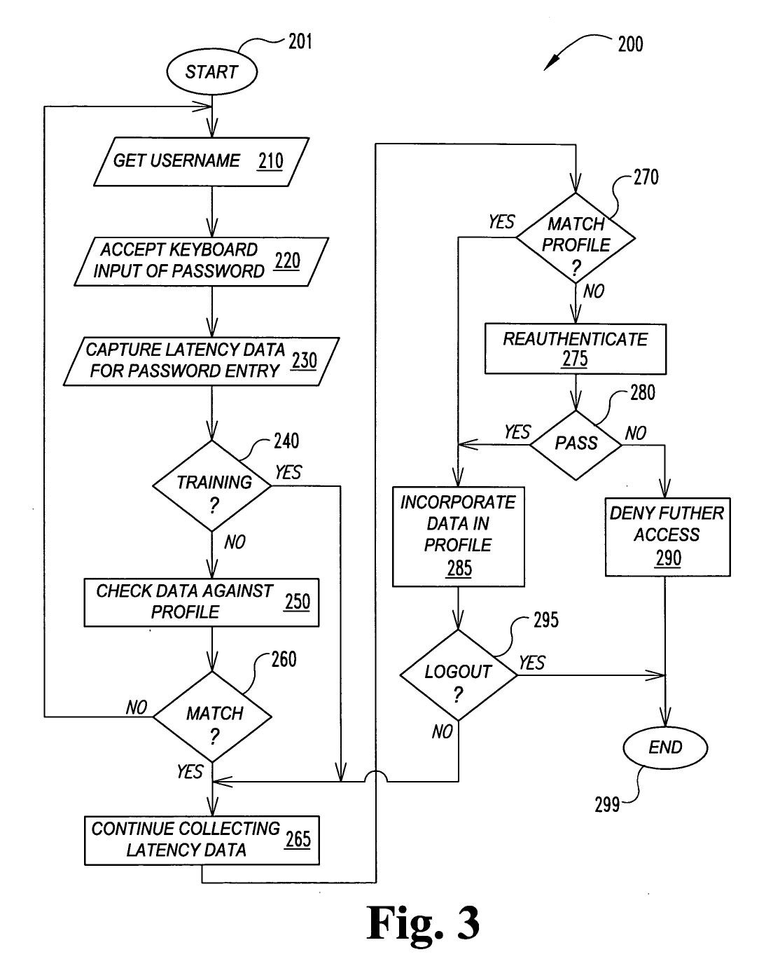

A flowchart describing this example embodiment is shown in FIG. 3. Process 200 begins at START point 201 in a state where a person is about to log into a workstation 140, for example. The system obtains a username for authentication at block 210, which may be a default, saved username from a prior login, a username typed by the person, a subject obtained from an identification device, or the like. The system accepts keyboard input of a password from the person at input block 220, simultaneously capturing keystroke latency data for the entry at input block 230.

Both here and elsewhere in process 200, when keystroke latency data is being collected, only data for selected sequences of characters (digraphs, trigraphs, or other n-graphs) is retained. These sequences may be stored explicitly (for example, in a list kept in a configuration file), characterized (for example, by one or more regular expressions), described in another fashion, or described by a combination of such techniques.

The system determines whether it is in a training mode at decision block 240. If not (a negative result), the captured data is checked against the profile for the purported user at block 250. At decision block 260, the system determines whether the captured latency data matches the profile for the purported user. If not (a negative result), process 200 returns to get a username at block 210 (perhaps using a different method than was used the first time through). If so (a positive result at block 260 ), the system continues to collect latency data as the person uses the computer (block 265 ).

Either periodically or upon the occurrence of one or more predetermined events, the system checks (see decision block 270 ) whether the data captured by the ongoing monitoring still matches the profile of the user that was authenticated at blocks 210-260. If not, the system seeks re-authentication of the user at block 275. Various methods for re-authentication may be used, including re-entry of the username and password, biometric authentication, or another technique as would occur to one skilled in the art.

The system determines at decision block 280 whether the re-authentication (at block 275 ) was successful. If so, or if the profile check at decision block 270 was successful, the system incorporates the newly captured data into the system's profiles by applying it to a neural network based on a genetic algorithm at block 285. The system then determines at decision block 295 whether the user's session is ending. If so, process 200 ends at END point 299. If not, process 200 returns to collecting additional latency data at block 265.

If the re-authentication at block 275 fails (as determined at block 280 ), then the system denies further access to the person at block 290, then ends at END point 299. Other consequences of failed authentication and re-authentication are discussed herein and will occur to those skilled in the art.

There are significant differences between the preferred embodiment of the present invention and the Bender, et al., method discussed above. Examples include the time-elements for which data is recorded, the key-combinations for which data is recorded, the “training” method used, and the authentication text that is analyzed. First, Bender, et al., record both dwell-time (how long the key is depressed) and flight-time (time from release of one key to depression of the next) with each keystroke. This is considered to be unrealistic because it cannot be universally applied to multiple keyboards having various levels of key pressure resistance. Further, these measurements are not easily applied to touch-pad keys such as those frequently found on notebook computers. Preferred embodiments of the present invention record only the time from initial depression of one key to the initial depression of the next (i.e., dwell and flight time combined).

Second, Bender requires the subject to type the same key phrase repeatedly, then determines which sets of keys produce the most reliable dwell and flight times. These specific keys and associated times are then used to identify the individual. Thus, data for various individuals relate to different key combinations (mini-rhythms). In contrast, a preferred embodiment of the present system uses the same specific key combinations for all subjects. While some training is still required, the present system typically requires much less rigorous training. In fact, subjects using this system may not even realize that the system is “learning” their characteristics.

Third, with respect to training, Bender states, “in the present invention it is the subject who learns, not the system.” Bender requires the subject to “learn” a key phrase so well that it can be typed without thinking (possibly invoking muscular memory among other things) and thus expects the subject to develop a pattern of typing for a given phrase. In contrast, the present system assumes that the subject already has certain innate patterns of typing (assuming they are proficient at typing) and thus does not require the subject to “learn” anything, only to demonstrate their pre-existing typing patterns. Rather, it is the preferred embodiment system that “learns” about the subject.

Fourth, Bender requires the same key words or phrase to be typed for authentication purposes as was used for training. In contrast, the present system allows for any words or phrases to be typed for purposes of authentication. This is possible because the system looks for the time between certain pairs or sets of keys/letters. The preferred embodiment is not necessarily concerned with the words in which the keys/letters are found.

To investigate the present system, a study was performed to determine whether the use of the genetic adaptive neural network based on password-length text alone could match imposter pass rates (IPR) of existing systems. Some existing methods had used user name, last name, first name and password (sometimes referred to as the Joyce or Gupta model). During the study, subjects were asked to type a line of text similar in length to a typical password. Ten subjects were asked to type a line of text similar to the length of a password fifteen times. Subjects were informed that the purpose was to measure their personal typing speed. Because the users only typed a simulated password, fewer measurements were taken, e.g., one word versus six in the prior model (password only versus password, user name, last name and first name). Thus, fewer observations and measurements were used to reflect a more realistic approach, necessary since the present embodiment is ultimately expected to be applied to a real security procedure against undesired entry to a computer system. FIG. 4 is a graph of the Average Latency Patterns for the Keystrokes for the Subjects recorded in this study.

For each subject's 15 observations, 10 observations were used in their in-sample data. Five observations were held-out as the out-of-sample data. In each sample, an equal number of “imposter” samples were drawn at random. Thus, each of the eight subjects had their own predictive models and their own in- and out-of-sample data sets. In-sample sets contained 10 “real” and 10 “imposter” observations. Out-of-sample sets contained 5 “real” and 5 “imposter” observations. Eight neural network models and eight linear models were prepared, one for each subject. Neural network models using various numbers of hidden nodes were tested. Results indicate that using five hidden nodes resulted in the best performance. For each model, a threshold level of 0.50 was used to determine whether the prediction was for the “real” subject, an “imposter.” A Confusion Matrix for each of the 8 linear and 8 neural network models is shown in Table 1_{[MRS1]}. Additionally, a summary Confusion Matrix was prepared using the sum of the matrices for each model type, as shown in Table 2_{[MRS2]}.

TABLE 1

| LINEAR MODEL | | | | NEURAL NETWORK 5 HIDDEN NODES | | | |
|---|---|---|---|---|---|---|---|
| | pred. | pred. | | | pred. | pred. | |
| | real | imposter | | | real | imposter | |
| KA | | | | KA | | | |
| act. real | 1 | 4 | 5 | act. real | 4 | 1 | 5 |
| act. imposter | 1 | 4 | 5 | act. imposter | 3 | 2 | 5 |
| | 2 | 8 | | | 7 | 3 | |
| Jma | | | | Jma | | | |
| act. real | 1 | 4 | 5 | act. real | 4 | 1 | 5 |
| act. imposter | 1 | 4 | 5 | act. imposter | 0 | 5 | 5 |
| | 2 | 8 | | | 4 | 6 | |
| AW | | | | AW | | | |
| act. real | 4 | 1 | 5 | act. real | 5 | 0 | 5 |
| act. imposter | 1 | 4 | 5 | act. imposter | 1 | 4 | 5 |
| | 5 | 5 | | | 6 | 4 | |
| IJ | | | | IJ | | | |
| act. real | 3 | 2 | 5 | act. real | 5 | 0 | 5 |
| act. imposter | 1 | 4 | 5 | act. imposter | 1 | 4 | 5 |
| | 4 | 6 | | | 6 | 4 | |
| Jmo | | | | Jmo | | | |
| act. real | 4 | 1 | 5 | act. real | 3 | 2 | 5 |
| act. imposter | 0 | 5 | 5 | act. imposter | 0 | 5 | 5 |
| | 4 | 6 | | | 3 | 7 | |
| KG | | | | KG | | | |
| act. real | 2 | 3 | 5 | act. real | 5 | 0 | 5 |
| act. imposter | 3 | 2 | 5 | act. imposter | 1 | 4 | 5 |
| | 5 | 5 | | | 6 | 4 | |
| PM | | | | PM | | | |
| act. real | 4 | 1 | 5 | act. real | 3 | 2 | 5 |
| act. imposter | 3 | 2 | 5 | act. imposter | 2 | 3 | 5 |
| | 7 | 3 | | | 5 | 5 | |
| AL | | | | AL | | | |
| act. real | 3 | 2 | 5 | act. real | 4 | 1 | 5 |
| act. imposter | 5 | 0 | 5 | act. imposter | 1 | 4 | 5 |
| | 8 | 0 | | | 5 | 5 | |

TABLE 2

| SUM-TOTALS, Linear | | | | | SUM-TOTALS, Neural Nets | | | | |
|---|---|---|---|---|---|---|---|---|---|
| | pred. | pred. | | false | | pred. | pred. | | false |
| Linear Sum | real | imposter | | alarm | NN Sum | real | imposter | | alarm |
| act. real | 22 | 18 | 40 | 0 | act. real | 33 | 7 | 40 | 0.175 |
| act. imposter | 15 | 25 | 40 | | act. imposter | 9 | 31 | 40 | |
| | 0.375 | | | | | 0.225 | | | |
| | imp pass | | | | | imp pass | | | |

In the practical application of a security feature based on keystroke latency, catching an imposter is far more important than occasionally inconveniencing the “real” subject by asking them to verify their identity. Depending on the required level of security, as long as secondary identity verification is not annoyingly inconvenient or frequent, it will be acceptable. It is expected that occasionally a subject will be distracted while typing, resulting in a false alarm and the invocation of a secondary identification procedure. For these reasons, the authors test the significance of the results only where they involve blocking or passing of imposters. The results of all imposters on the eight (8) linear models and the eight (8) neural network models were tested in aggregate using the Wilcoxon Signed-Ranks Test of Significance, the results of which are shown in Table 3_{[MRS3]}.

TABLE 3
Test Statistics^{b}

| | NNET-LINEAR |
|---|---|
| Z | −2.065^{a} |
| Asymp. Sig. (2-tailed) | 0.039 |

^{a}Based on positive ranks.
^{b}Wilcoxon Signed Ranks Test

The system of this invention increases in accuracy as it develops more historical data for a particular user. The system continuously develops a history or library of keystrokes for that user that enables it to more accurately identify an imposter using that user's login and/or password. When a new user begins on the system, the system may experience a greater rate of false signals if the user's immediate keystroke pattern falls outside of the system's yet-to-be developed data library for that user. A new user's library will naturally be in an infancy stage due to the lack of keystroke data for that particular user. Once the library develops more keystroke latency data, its accuracy will increase and its frequency of false signals will decrease.

Some existing models of user authentication are too cumbersome for practical application. Some models require subjects to type far more data than today's users are accustomed to typing for security clearance into a system (first name, last name, user name, and password). Other models are based on models inconsistent with the majority of computer access procedures (user names only, passwords for long term security keys, etc). For this reason, the preferred embodiment of the present invention focuses on only a few keystrokes that mimic what the typical user would encounter in day-to-day activities. The results show the neural network model with fewer independent variables produced results slightly better than prior models in terms of imposter pass-rate and false alarms. FIG. 5 shows a comparison of results between the present preferred embodiment system versus linear or Joyce and Gupta models.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A system, comprising a processor and a computer-readable medium, the medium being encoded with programming instructions executable by the processor to:
accept input of a password by a person via a keyboard;
capture keystroke latencies as the person enters the password, wherein the keystroke latencies are only those between characters in a predetermined set of character patterns;
apply the keystroke latencies as input to a neural network that implements a genetic algorithm; and
based on the output of the neural network, generate an authentication signal that relates to whether the person is a particular user.

2. The system of claim 1, wherein the predetermined set is enumerated in the medium.

3. The system of claim 1, wherein the predetermined set is characterized in the medium.

4. The system of claim 1, wherein the authorization signal is a binary signal.

5. The system of claim 1, wherein the authorization signal takes one among three or more values that indicate different confidence levels in the identity of the person as the user.

6. A method of maintaining computer security, comprising:
maintaining a collection of latency profiles, each for a particular authenticated user on a computer system;
monitoring the keystroke latencies as a person using the computer system types a predetermined set of n-graphs;
determining a current user as whom the person is logged in;
determining whether the keystroke latencies match the latency profile for the current user; and
if the keystroke latencies do not match the latency profile for the current user, generating an alarm signal.

7. The method of claim 6, wherein the alarm signal is a log entry.

8. The method of claim 6, wherein the alarm signal is a message to security personnel.

9. The method of claim 6, wherein the alarm signal is a denial to the user of further access to the computer system.

10. The method of claim 6, wherein the alarm signal is a request for reauthentication of the person as the user.

11. A system, including:
a keystroke latency monitor that records the latency between keystrokes that form one of a predetermined set of n-graphs of keyboard input by a person;
storage that contains a digital keystroke latency signature for a particular user;
a neural network that receives latency data from the monitor, evaluates the latency data against the digital keystroke latency signature, and provides an output signal when the variation between the latency data and the signature exceeds a predetermined threshold.

12. The system of claim 11, wherein the neural network is updated using a genetic algorithm.

13. The system of claim 11, wherein the output signal indicates that the person may be in an extreme emotional state.

14. The system of claim 11, wherein the output signal provides a warning to the person.

15. The system of claim 11, wherein the output signal is provided when the system is in an instant messaging mode.

16. The system of claim 15, wherein the output signal provides a warning to the person.

17. The system of claim 15, wherein the output signal provides a warning to the recipient of the typed text.

18. The system of claim 11, wherein the output signal is provided to the recipient of an e-mail message sent by the person.
